(19) United States
(12) Patent Application Publication
(10) Pub. No.: US 2003/0048904 A1
(43) Pub. Date: Mar. 13, 2003

(54) Web-based biometric authorization apparatus

(76) Inventors: Po-Tong Wang, Taipei City (TW); Sheng-Ming Wu, Taipei City (TW)

Correspondence Address: Po-Tong WANG, PO Box 82-144, TAIPEI, TW

(21) Appl. No.: 09/947,518

(22) Filed: Sep. 7, 2001

(51) Int. Cl. H04K 1/00

(52) U.S. Cl. 380/270; 713/185

(57) ABSTRACT

This invention represents a Web-based biometric authorization apparatus. The present invention relates to live biometric characteristics which are captured by a biometric capture device and, in particular, to the Biometric Identification Record (BIR) and personal information which are stored in a digitized data storage apparatus. It is therefore an object of the present invention to provide the further data process which includes compression and decompression function, encryption and decryption function, and to provide the BIR process which relates to calculation, collation and verification as a secured mechanism. The apparatus is operatively coupled to a remote site so as to establish an Internet communication link through wired or wireless communications. Therefore, the biometric verification is performed with peripheral devices such as POS terminals, ATM terminals, credit card reader, access control or other control mechanism. Also, the present invention is capable embedded in portable devices such as cellular phones, PDA, IA products, Bluetooth device and wired or wireless communications. Utilizing Web-based biometric authorization apparatus is a secure method for protecting consumers against hackers and theft.

### BACKGROUND OF THE INVENTION

Internet access has become the fastest way to get the latest information, exchange real-time message and connect with the world easily in these years. Also, in this cyber-everything age, more and more consumers carry out business transactions and purchase goods via Internet. Both of increasing security problems and unauthorized access to computer data bases are major concern today and in the future. Therefore, in response to the need for enhancing security and personal identification, biometric techniques of verification utilize personal specific physical traits and unique biometric characteristics to make individual identification.

### SUMMARY OF THE INVENTION

The present invention provides a Web-based biometric authorization apparatus which comprises a biometric capture device for capturing live biometric characteristics (i.e., fingerprints, voiceprints, iris, retina, face and palm print) and a digitized data storage apparatus for storing the BIR and personal information. It is therefore an object of the present invention to provide the further process that includes compression and decompression function, encryption and decryption function of personal information and the BIR. It is an object of this invention to perform the BIR with calculation, collation and verification process as a secured mechanism. It is a further object of the present invention to perform secured biometric verification by coupling to a remote site and establishing a communication network link through wired or wireless communications. Therefore, the biometric verification is performed with peripheral devices such as POS terminals, ATM terminals, credit card reader, access control or other control mechanism. Also, the present invention is capable embedded in portable devices such as cellular phones, PDA, IA products, Bluetooth device and wired or wireless communications. Utilizing Web-based biometric authorization apparatus is a secure method for protecting consumers against hackers and theft.

### BRIEF DESCRIPTION OF THE DRAWINGS

FIG. 1 is a block diagram showing the present invention.

FIG. 2 is a flow chart to illustrate how to perform the present invention.

### DETAILED DESCRIPTION OF THE PREFERRED EMBODIMENT

Illustration of the following serial numbers

1. CPU

2. Biometric Capture Device

3. Digitized data storage device

4. Input device

5. Output device

6. Wired or wireless communication network protocol chips

7. Personal information and live physically immutable identification credentials of a user

8. Collation and comparison

9. The user is permitted to carry out his or her business transactions

10. Prohibited transactions or deny access

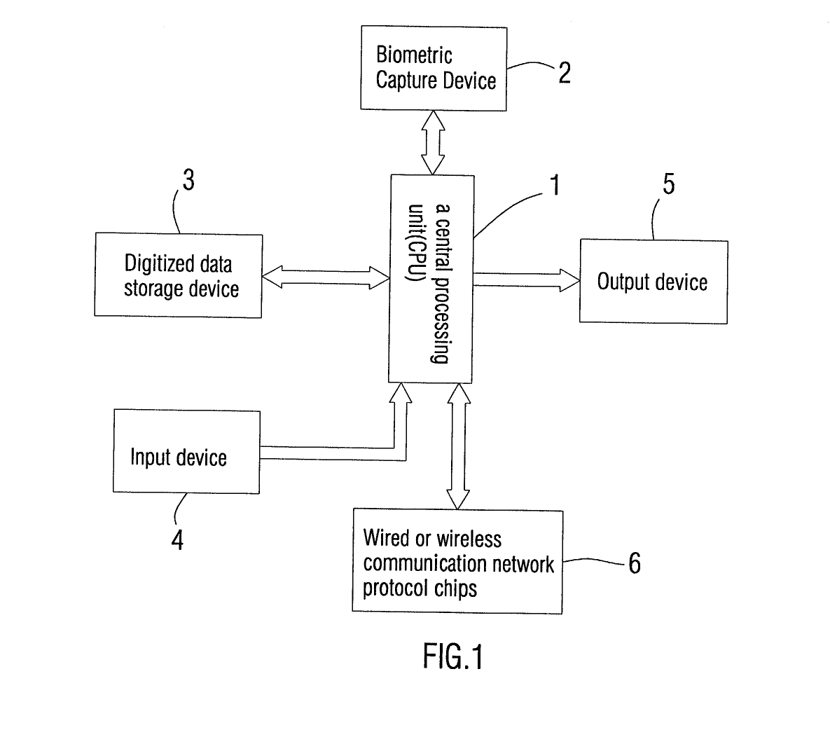

As seen in FIG. 1, the present invention provides a Web-based biometric authorization apparatus which comprises a CPU, wire or wireless communication protocol chips, a Biometric Capture Device, a digitized data storage device, an input and an output device.

The CPU1 is utilized to perform the biometric authorization process and establish an Internet communication link. The process includes compression and decompression function, encryption and decryption function of personal information and the Biometric Identification Record (BIR). The BIR process involves calculation, collation and verification process as a secured mechanism.

According to the present invention, wire and wireless communication network protocol chips which comprise RISC CPU, CISC CPU, DSP, FPGA, CPLD and NET ASIC are operatively coupled to a remote site to establish an Internet communication link through wired or wireless communications. As for the elements of chips may involve system-on-a-chip (SOC), system-on-multiple-integrated-chips and system-on-multiple-chips. And the communication protocol includes the following types: TCP/IP, UDP, RARP, IGMP and PPP.

The Biometric Capture Device2, which is for capturing live physically immutable identification credentials of a user, includes fingerprint image sensor, voiceprint input device, iris image sensor, retina image sensor, face image sensor and handprint image sensor. The digitized data storage device3 is for storing temporary process data, personal information and the BIR of the user.

An input device4 maybe be a card reader, a keyboard, a microphone, a 1D/2D bar code reader, a digital board, a magnetic strip apparatus, CD, DVD, a touch screen, radio frequency (RF) receiver, infrared (IR) receiver, Bluetooth device, modem or other portable media with I/O capability for reading and writing. The card reader interface may include magnetic strip card, IC card, smart card, optical card, EAROM card or other portable storage devices with digital data memory.

An output device5 can be a LCD, OLED, LED, any other visual displays, speaker, relay, ON/OFF control device with capability for writing, magnetic strip apparatus, RF Transmitter, IR Transmitter, Bluetooth device and modem.

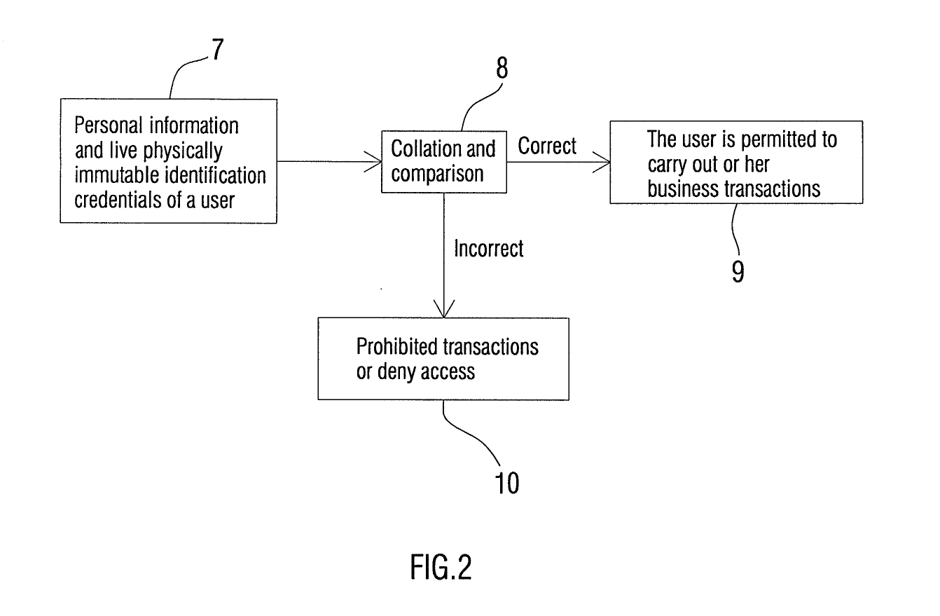

The present invention can be applied to POS terminals, ATM terminals, credit card reader, access control or other control mechanism. Also, the present invention is capable embedded in portable devices such as cellular phones, PDA, IA products, Bluetooth device and wired or wireless communications. The apparatus is operatively coupled to a remote site and establish a communication network link through wired or wireless communication network protocol chips6. Therefore, utilizing Web-based biometric authorization apparatus is a secure method for protecting consumers against hackers and theft. As seen in FIG. 2, the present invention provides a Web-based biometric authorization apparatus which comprises an input device and a biometric capture device for capturing both of personal information and live physically immutable identification credentials7 (i.e., fingerprints, voiceprints, iris, retina, face and palm print) of a user. The biometric verification is performed by collating8 digitized BIR stored in the digitized data storage device and activated biometric characteristics. The CPU is requested to process the BIR through compression and decompression function, encryption and decryption function and to provide the BIR with calculation, collation and verification process as a secured mechanism. If the user is verified, digital certificate will be downloaded via the output device and the user is permitted to carry out his or her business transactions9. If the result is false, the user will be prohibited to carry out transactions and denied access10.

In conclusion, the present invention has the following advantages:

1. The present invention can be applied to POS terminals, ATM terminals, credit card reader, access control or other control mechanism.

2. The biometric verification provides high security of personal identification when the user is doing business transactions and economic activities.

3. The present invention is capable embedded in portable devices such as cellular phones, PDA, IA products, Bluetooth device and wired or wireless portable devices

4. The present invention can be utilized in the application of business and industry.

I claim:

1. A Web-based biometric authorization apparatus, comprising:
a CPU for performing the biometric verification through compression and decompression function, encryption and decryption function of the BIR, and for providing said BIR with calculation, collation and verification process as a secured mechanism;
a wired or wireless communication network protocol chip, operatively coupled to a remote site, for establishing a communication network link through wired or wireless communications;
a biometric capture device means for capturing live physically immutable identification credentials (i.e., fingerprints, voiceprints, iris, retina, face and palm print) of a user;
an input device;
an output device; and
a digitized data storage device means for storing temporary process data, personal information and said BIR of the user.

2. The method of claim 1 wherein said wired or wireless communication network protocol means for comprising TCP/IP, UDP, RARP, IGMP and PPP.

3. The method of claim 1 wherein said wired or wireless communication network protocol chip means for comprising RISC CPU, CISC CPU, DSP, FPGA, CPLD and NET ASIC.

4. The method of claim 1 wherein said biometric capture device means for comprising Fingerprint Image Sensor, Voiceprint Input Device, Iris Image Sensor, Retina Image Sensor, Face Image Sensor and Handprint Image Sensor.

5. The method of claim 1 wherein said input device means for comprising a card reader, a keyboard, a microphone, a 1D/2D bar code reader, a digital board, a magnetic strip apparatus, CD, DVD, a touch screen, radio frequency (RF) receiver, infrared (IR) receiver, Bluetooth device, modem or other portable media with I/O capability for reading and writing.

6. The method of claim 1 wherein said output device means for comprising LCD, OLED, LED, any other visual displays, speaker, Relay, ON/OFF control device with capability for writing, magnetic strip apparatus, RF Transmitter, IR Transmitter, Bluetooth device and modem.

7. The method of claim 1 wherein said chips of said CPU and said wired or wireless communication network protocol comprise the following types: system-on-a-chip (SOC), system-on-multiple-integrated-chips and system-on-multiple-chips.

8.The method of claim 1 wherein said card reader means for comprising magnetic strip card, IC card, smart card, optical card, EAROM card or other portable storage devices with digital data memory.
